(19) United States
(12) Patent Application Publication
(10) Pub. No.: US 2017/0371177 A1
(43) Pub. Date: Dec. 28, 2017

(54) EYEGLASS RETAINER DEVICE AND METHODS OF USING THE SAME

(71) Applicant: Richard J. Yribarren, Tranquillity, CA (US)

(72) Inventor: Richard J. Yribarren, Tranquillity, CA (US)

(21) Appl. No.: 15/188,988

(22) Filed: Jun. 22, 2016

(51) Int. Cl. G02C 5/14

(52) U.S. Cl. CPC G02C 5/143

(57) ABSTRACT

An eyewear retention device that comprises two retaining devices, each meant to be positioned on a temple member of a pair of eyeglasses. The retainer devices are meant to be positioned between the concha and pinna of the ear so that hold the eyeglasses on the nose of the wearer securely at the wearer's desired portion without any slippage of the eyeglasses along the nose.

### FIELD OF THE INVENTION

The present invention relates to eyewear retaining devices and more particularly eyewear retaining devices that hold eyewear in desirable position, and methods of using the same.

### DISCUSSION OF THE BACKGROUND

Eyeglasses generally include a frame consisting of a front and two temples. The front is generally formed by two eyewires which hold the lenses and are connected by a bridge with two nose pads. The two temples extend from the lateral ends of the front in a reward manner. The temples and nose pads support the frame on the head of the wearer in a position in which the lenses are in front of the wear's eyes at a desired, optimal position. However, due to the weight of the lenses and the movement of the wearer, the eyeglasses may easily move from the optimal position causing the wearer to often adjust or reposition their eyeglasses. A simple movement of leaning over in a forward manner may sufficiently shift the eyeglasses out of position where the lenses are no longer in an optimal position for the wearer to use. Worse, sudden movements or activity may dislodge or the eye glasses or make the eyeglasses fall off the wearer. It is important that eyeglasses stay in an optimal place for those who require them for everyday activities. Occasions where the eyeglasses in a non-optimal position or a dislodged position may subject the wearer to hazardous situations while they adjust the eyeglasses back to an optimal position. Moreover, eyeglasses may be damaged if they fall from the wearer.

There are various devices which retain eyeglasses (e.g. lanyards) used to prevent eyeglasses from falling to the ground; however, these devices do not keep the eyeglasses from slipping on the dorsal portion of the bridge of the nose. Furthermore, wearers vary with regard to the position at which they desire the nose pads to rest on the nose (e.g., some wearers like a tight fit with the nose pads high on the dorsal portion of the bridge of the nose, some like the glasses positioned near the end of the nose for reading or other close-up views). Therefore, there is a need for a device to prevent eye glasses from slipping from the desired, optimal position, become dislodged, or falling completely off the wearer's face.

### SUMMARY OF THE INVENTION

The present invention provides eyeglasses retention devices and methods for using the same. The eyeglasses retention devices and methods for using the same offer significant advancements for keeping eyeglasses secure on a human head in a desired, optimal position for use.

It is an object of the present invention to provide a device that can hold eyewear (e.g., reading glasses, sunglasses, etc.) in optimal position with the bar (i.e., bridge between the two lenses) and nose pads of the glasses positioned at a desirable position on the nose (e.g., tight on the bridge of the nose, such that the lenses are in front of a wearer's eyes). It is also an object of the present invention to allow provide a universal device that may accommodate the shape of any temple of any eyewear. It is a further object of the present invention to allow for any eyewear to be securely positioned at the user's desired position on the nose.

The present invention relates to a device for securing eyewear to a human head and preventing the eyewear nose pads from slipping from an optimal position on the nose (e.g., on the dorsal portion of the nose at the bridge). Embodiments of the present invention may include a first retention device having a central passage therethrough for receiving a temple of a pair of eyeglasses and having a particular shape (e.g., an o-shaped ring, a rectangularly shaped device, etc.) and a second retention device having a central passage therethrough for receiving a temple of a pair of eyeglasses and having a particular shape (e.g. an o-shaped ring, a rectangularly shaped device, etc.). A temple portion of a pair of eyeglasses may be passed through the central opening and the retaining device may be positioned along the temple to the user's preference. The retention devices may be positioned such that they are between the concha and the pinna of the wearer's ear to keep eyewear secure on the wearer's face. It is a goal of the present invention to allow for the secure placement of the nose pads on nose subject to the wearer's desired positioning. It is a further goal of the present invention that the retaining devices be low profile and comfortable to the wearer. The retaining devices may be relatively small (e.g., having an outer diameter in a range of about ⅛ in. to about 1 in., such as about ⅜ in. or any value or range of values therein). Due to the low profile of the retaining devices, the user can secure his eyeglasses in a desired position without any awkward eyeglass retainer (e.g., a lanyard) in clear view. The retaining devices of the present are positioned behind the pinna and concha of the ear and thus do not present an awkward, gawky appearance, unlike conventional eyeglass retainers. They also do not present any risk of catching on nearby objects (e.g., tree branches, etc.) as the wearer moves around because they are positioned behind the pinna of the ear.

The user may prefer that the retaining devices of the present invention be positioned at different points along the temples of the eyeglasses, such that the eyeglasses may be retained at different positions along the user's nose. For example and without limitation, an individual who is farsighted may prefer eyewear be positioned further down the dorsal portion of the nose (towards the tip of the nose) so that the wearer may look through the lenses of the eyewear towards reference materials then look up in a manner where the wearer is no longer looking through the lenses of the eyewear. The present invention would allow one to place two retaining devices on the temple of the eyewear in a manner that secures the eyewear near the tip of the nose (e.g. placing the retaining devices near the end of the temple). In another example, without limitation, an individual who requires use of eyewear for everyday activities, the two retaining device may be placed on the temple and positioned between the concha and the pinna so that the nose pads are high up on the dorsal portion of the bridge of the nose close to the wearer's eyes. The above examples are not meant to limit the invention; rather one with ordinary skill in the art will understand that the present invention is meant to secure any eyewear to the face of any wearer in his desired eyeglass position.

The retaining device includes two o-shaped rings with a central opening that may be made out of a flexible material (e.g. latex, silicone rubber, etc.) to accommodate eyeglasses having temples of various shapes and sizes. The flexible nature of the o-shaped ring gives one the ability to slide the retaining devices over temples of various shapes and sizes. In other embodiments, the shape of the retaining device may be other appropriate perimeter shapes, for example, without limiting the invention, a square, triangle, rectangle, etc. The perimeter shape of the central opening also may be any appropriate shape as to accommodate the temple of eyewear, for example, without limiting the invention, a square, triangle, rectangle, etc.

The retaining devices may have an outer diameter in a range of about ⅛ inch to about 1 inch (e.g., in a range of about ⅛ inch to about ½ inch, about ⅜ in., or any value or other range of values therein), and an inner diameter in a range of about 1/32 inch to about ½ inch (e.g., in a range of about 1/32 inch to about ¼ inch, about 1/16 in., or any value or other range of values therein) as to accommodate all sizes and shapes of the temple portion of eyewear while being low profile and comfortable to the wearer.

Several embodiments are discussed below, but these example embodiments shall not to be interpreted as an exhaustive list. One with ordinary skill in the art will recognize that the scope of the present invention includes further variations and equivalents to the specific examples described herein.

In one embodiment, the present invention relates to an eyewear retention apparatus comprising a first retaining device with a first central opening operable to receive a first temple of a pair of eyeglasses, where the first retaining device is resilient and deformable such that it is operable to receive eyeglass temples of various shapes and sizes' and a second retaining device with a second central opening operable to receive a second temple of the pair of eyeglasses, wherein the second retaining device is resilient and deformable such that it is operable to receive eyeglass temples of various shapes and sizes.

In another embodiment, the present invention relates to a method for securing eyewear to a human head and prevent the eyewear from slipping along the wearer's nose comprising placing a first retaining device with a first central opening over a distal end of a first temple of a pair of eyeglasses; positioning the first retaining device along the first temple at a first position; positioning a second retaining device with a second central opening over a distal end of a second temple of the pair of eyeglasses; positioning the second retaining device along the second temple at a second position; and placing the eyeglasses on the head such that the first retaining device is placed between the concha and pinna of a first ear and the second retaining device is placed between the concha and pinna of a second ear.

In another embodiment, the present invention relates to a method for securing eyewear to a human head and prevent the eyewear from slipping from the bridge of the nose comprising placing a first retaining device having a central opening over a distal end of a first temple of a pair of eyeglasses, wherein the first retaining device is resilient and deformable such that it is operable to receive eyeglass temples of various shapes and sizes, placing a second retaining device having a central opening over a distal end of a second temple of the pair of eyeglasses, wherein the retaining device is resilient and deformable such that it is operable to receive eyeglass temples of various shapes and sizes, and placing the eyewear on the face of the wearer, such that the first retaining device is placed between the concha and pinna of a first ear and the second retaining device is placed between the concha and pinna of a second ear.

Additional aspects and objects of the invention will be apparent from the detailed descriptions and the claims herein.

### BRIEF DESCRIPTION OF THE DRAWINGS

FIG. 1 is a frontal view, a perspective view, and a side view of an eyewear retaining device according to an embodiment of the present invention.

FIG. 2 is a perspective view of an eyewear retaining device according to an embodiment of the present invention, with the eyewear retaining device attached to a pair of eyeglasses.

FIG. 3 is a side view of an eyewear retaining device according to an embodiment of the present invention, with the eyewear retaining device attached to a pair of glasses, and the eyewear retaining device and the glasses being worn by a person.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. Conversely the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

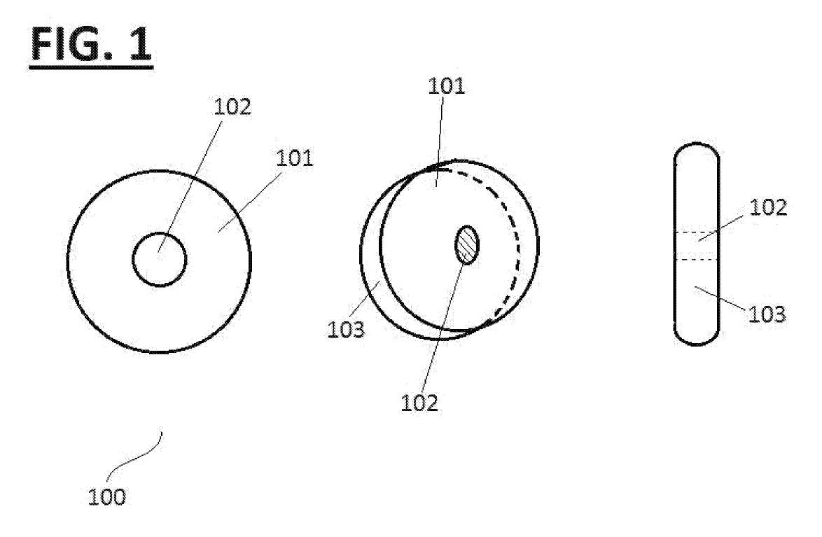

Referring to the drawings, without limitation, wherein like reference characters designate like or corresponding parts throughout the several views, and referring particularly to FIGS. 1-3, it is seen that the present invention is drawn to eyeglass retaining devices and methods of using such retaining devices. However, the embodiments shown in the figures and described below are exemplary and that the present invention is not limited to such embodiments. One with ordinary skill in the art will recognize that alteration, for example, in the shape of the invention and the diameters, as well as other alterations fall within the spirit and the scope of the present invention.

FIG. 1, without limiting the invention, illustrates an eyewear retainer device 100 from three different vantage points. The eyewear retaining device 100 has an o-ring 101, a central opening 102, and a height 103. The outer part of the o-ring is outer diameter of the retainer device which may be in a range of about ⅛ inch to about 1 inch (e.g., in a range of about ⅛ inch to about ½ inch, about ⅜ in., or any value or other range of values therein). The o-ring is made up of a flexible material (e.g. silicone rubber, neoprene, rubber foam, etc.) so that it may receive be stretched and deformed to receive eyeglass temples of various shapes and sizes. The o-ring 101 has a relatively low profile while still being operable to abut the wearer's head at a desired position between the concha and pinna of the ear and thereby secure the eyewear to the wearer's head. The o-ring 101 has a central opening 102 with a diameter (the inner diameter of the retaining device) in a range of about 1/32 inch to about ½ inch (e.g., in a range of about 1/16 inch to about ¼ inch, about 1/16 in., or any value or other range of values therein), allowing the retaining device 100 to as to accommodate the distal ends of temples of various sizes and shapes. The thickness 103 of the eyewear retaining device is in a range of about 1/16 inch to about ½ inch so that it may secure the eyeglasses to the wearer without slipping from the user's placement thereof on the temple and without being easily seen by others when positioned behind the ear.

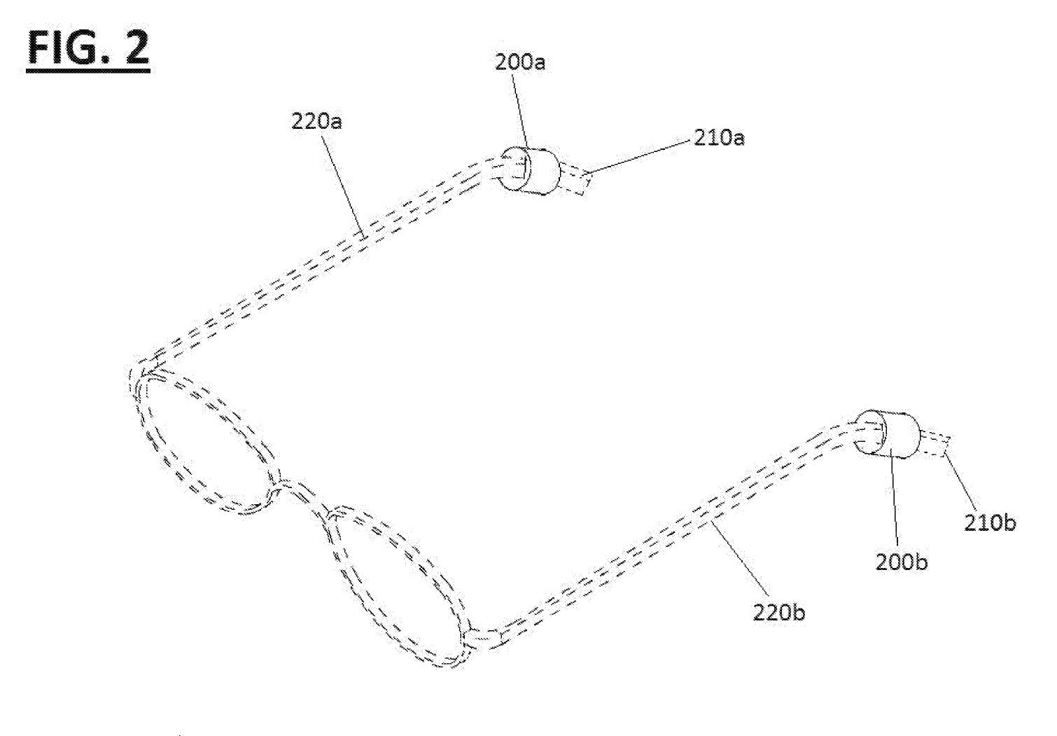

FIG. 2 without limiting the present invention, shows the eyewear retaining devices 200a and 200b on the temples 220a and 220b of a pair of glasses. The user may slide the eyewear retaining devices 200a and 200b over the distal end of the temple 210a and 210b to a desired point along the temple. The desired point along the temple may vary between users due to differences in the use of eyeglasses (e.g., some wearers like a tight fit with the nose pads high on the dorsal portion of the bridge of the nose, some like the glasses positioned near the end of the nose for reading or other close-up views). Once the retaining devices 200a and 200b are at desired positions along the temples 210a and 210b, the eyeglasses may be donned by the user and the eyeglasses may be positioned on the user's head such that the retaining devices 200a and 200b are placed between the concha and pinna of the ear to thereby hold the temples 220a and 220b and the rest of the eyeglasses in a static position. The central opening (not shown) of the eyewear retaining devices 200a and 200b are meant to accommodate any shape of temple (e.g. rectangular, circular, etc).

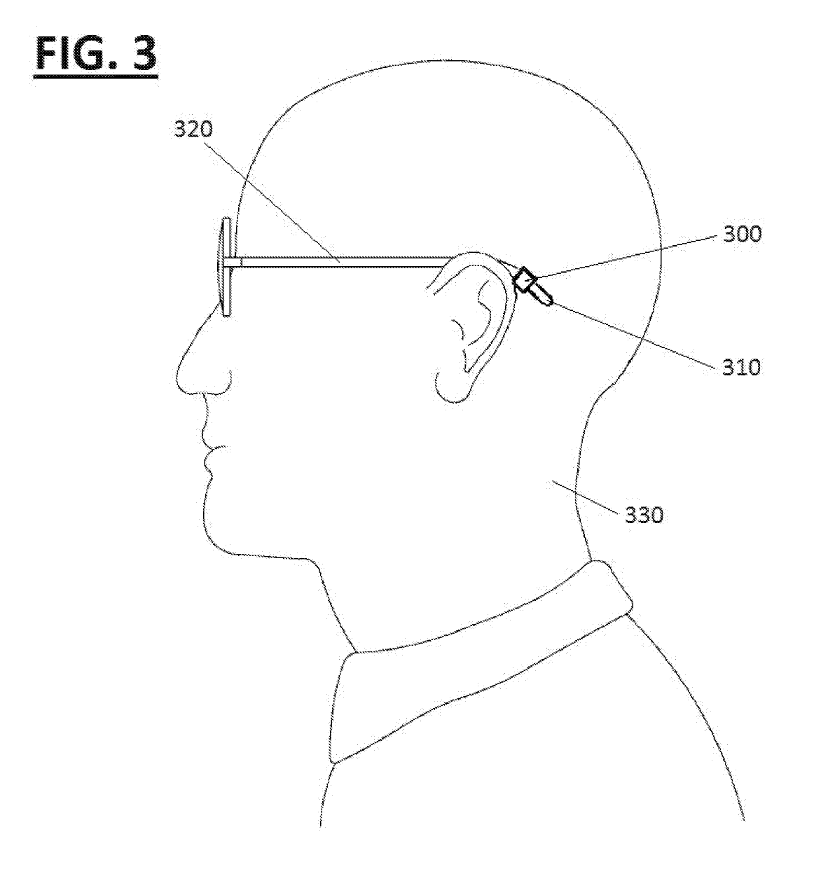

FIG. 3, without limitation, shows a side view of the eyewear retaining device 300 in use by a wearer 330. The eyewear retaining device 300 is shown attached to a pair of eyeglass worn by a wearer 330. The wearer may slide the eyewear retaining device 300 over the distal end 310 of the temple 320 and position it on the temple 320 so that it will hold the eyeglasses in the desired position. In FIG. 3, the eyeglasses are shown as held snugly to the bridge of a wearer's nose in the proper position such that the lenses are properly in front of the person's eyes. However, it is to be understood that the wearer may prefer that the eyeglasses are positioned at the end of the nose or some other intermediate position along the nose, and that the retaining devices may be positioned along the temples accordingly. One with ordinary skill in the art will appreciate that the user can slide the eyewear retaining device 300 towards the distal end of the temple 310 so that the eyeglasses may be positioned anywhere on the dorsal portion of the nose of the wearer 330 and still remain snug. The eyewear retaining device 300 can also be manipulated and moved while the wearer 330 has their glasses in place to position the eyewear retaining device in a desired place between the concha and pinna for optimal comfort.

### CONCLUSION/SUMMARY

The present invention provides a device and methods for using the same for an eyeglass retainer device. It is to be understood that variations, modifications, and permutations of embodiments of the present invention, and uses thereof, may be made without departing from the scope of the invention. It is also to be understood that the present invention is not limited by the specific embodiments, descriptions, or illustrations or combinations of either components or steps disclosed herein. The embodiments were chosen and described in order to best explain the principles of the invention and its practical application, to thereby enable others skilled in the art to best utilize the invention and various embodiments with various modifications as are suited to the particular use contemplated. Although reference has been made to the accompanying figures, it is to be appreciated that these figures are exemplary and are not meant to limit the scope of the invention. It is intended that the scope of the invention be defined by the claims appended hereto and their equivalents.

What is claimed:

1. An eyewear retention apparatus comprising:
a. a first retaining device with a first central opening operable to receive a first temple of a pair of eyeglasses, wherein said first retaining device is resilient and deformable such that it is operable to receive eyeglass temples of various shapes and sizes, and
b. a second retaining device with a second central opening operable to receive a second temple of said pair of eyeglasses, wherein said second retaining device is resilient and deformable such that it is operable to receive eyeglass temples of various shapes and sizes.

2. The eyewear retaining apparatus of claim 1, wherein said first retaining device and second retaining device have an o-ring shape.

3. The eyewear retaining apparatus of claim 1, wherein said first retaining device and second retaining device have a rectangular shape.

4. The eyewear retaining apparatus of claim 1, wherein said first retaining device and said second retaining device each have an outer diameter of up to about ½ inch.

5. The eyewear retaining apparatus of claim 1, wherein said first central opening and said second central opening each have an inner diameter of up to about ⅛ inch.

6. A method for securing eyewear to a human head and prevent the eyewear from slipping along the wearer's nose comprising:
a. placing a first retaining device with a first central opening over a distal end of a first temple of a pair of eyeglasses,
b. positioning said first retaining device along said first temple at a first position,
c. positioning a second retaining device with a second central opening over a distal end of a second temple of said pair of eyeglasses; and
d. positioning said second retaining device along said second temple at a second position; and
e. placing said eyeglasses on the head such that the first retaining device is placed between the concha and pinna of a first ear and the second retaining device is placed between the concha and pinna of a second ear.

7. The method of claim 6, wherein said first retaining device and said second retaining device are o-shaped rings that are resilient and deformable such that they are operable to receive eyeglass temples of various shapes and sizes.

8. The method of claim 6, further comprising securing the eyewear to the bridge of the nose of the wearer when said eyeglasses are placed on the head.

9. The method of claim 8, further comprising adjusting the position of said first retaining device on said first temple and said second retaining device on said second temple so that the eyeglasses are held in positioned on the end of the nose.

10. The method of claim 6, wherein said first retaining device and said second retaining device each have an outer diameter of up to about ½ inch.

11. The method of claim 6, wherein said first central opening and said second central opening each have an inner diameter of up to about ⅛ inch.

12. A method for securing eyewear to a human head and prevent the eyewear from slipping from the bridge of the nose comprising:
a. placing a first retaining device having a central opening over a distal end of a first temple of a pair of eyeglasses, wherein said first retaining device is resilient and deformable such that it is operable to receive eyeglass temples of various shapes and sizes,
b. placing a second retaining device having a central opening over a distal end of a second temple of said pair of eyeglasses, wherein said retaining device is resilient and deformable such that it is operable to receive eyeglass temples of various shapes and sizes, and
c. placing said eyewear on the face of the wearer, such that the first retaining device is placed between the concha and pinna of a first ear and the second retaining device is placed between the concha and pinna of a second ear.

13. The method of claim 12, wherein said first and second retaining devices comprise a resilient material selected from the group consisting of silicone rubber.

14. The method of claim 12, further comprising securing the eyewear to the bridge of the nose of the wearer when said eyeglasses are placed on the head.

15. The method of claim 14, further comprising adjusting the position of said first retaining device on said first temple and said second retaining device on said second temple so that the eyeglasses are held in positioned on the end of the nose.

16. The method of claim 12, wherein said first retaining device and said second retaining device each have an outer diameter of up to about ½ inch.

17. The method of claim 12, wherein said first central opening and said second central opening each have an inner diameter of up to about ⅛ inch.

18. The method of claim 12, wherein said first retaining device and second retaining device have an o-ring shape.

19. The method of claim 12, wherein said first retaining device and second retaining device have a rectangular shape.

20. The method of claim 12, wherein said first central opening and said second central opening each have an inner diameter of up to about 1/16 inch, and said first retaining device and said second retaining device each have an outer diameter of up to about ⅜ inch.
